(19) United States
(12) Patent Application Publication
(10) Pub. No.: US 2026/0056924 A1
(43) Pub. Date: Feb. 26, 2026

(54) ENHANCED OCR DATA PROCESSING THROUGH DATA ENRICHMENT AND CONTEXTUAL TAGGING FOR LLMS

(71) Applicant: ETON SOLUTIONS, L.P., Morrisville, NC (US)

(72) Inventor: Muralidhran NADARAJAH, Durham, NC (US)

(21) Appl. No.: 19/034,211

(22) Filed: Jan. 22, 2025

Related U.S. Application Data
(60) Provisional application No. 63/623,712, filed on Jan. 22, 2024.

(51) Int. Cl. G06F 16/215; G06F 40/106; G06F 40/30

(52) U.S. Cl. CPC G06F 16/215; G06F 40/106; G06F 40/30

(57) ABSTRACT

A method and system are disclosed for improving the accuracy, efficiency, and scalability of data interpretation and extraction of structured data from unstructured documents utilizing Large Language Models (LLMs). Applicable in finance, healthcare, legal, and government contexts, the disclosed invention addresses limitations of conventional Optical Character Recognition (OCR), machine learning, and LLM-based methods. In particular, the system and method incorporate feedback loops for continuous learning and leverage pre-processing, contextual tagging, customized prompt engineering, and post-processing to achieve robust data extraction. By integrating data enrichment techniques, the invention manages the inherent complexities of multilingual documents and evolving content standards.

### CROSS-REFERENCE TO RELATED APPLICATIONS

This patent application is a non-provisional patent application based on and takes priority from U.S. provisional patent application Ser. No. 63/623,712 entitled “Enhanced OCR Data Processing through Data Enrichment and Contextual Tagging for LLMs,” and filed on Jan. 22, 2024, which is incorporated by reference herein in its entirety.

### FIELD

Implementations disclosed herein relate, in general, to information management technology and specifically to artificial intelligence (AI) based systems.

### SUMMARY

The technology disclosed herein provides a scalable system and method designed for high-volume data extraction, adaptable across multiple document standards, and focused on improving accuracy. Its modular architecture supports independent updates to individual components, ensuring long-term maintainability and flexibility.

Implementations of the technology disclosed herein include:

Pre-processing of Input Text that includes conversion and flattening of multi-layer documents into a single-layer format while preserving context and structure, for example via Recursive X-Y cut or Voronoi-based segmentation and handling of various document formats and layouts, including single-/multi-column texts, tables with merged cells, and nested headers.

Data Enrichment including utilization of knowledge graphs, metadata, and machine learning models (e.g., decision trees, neural networks) to add contextually relevant tags, thereby providing an enriched input for the LLM. Here the value of the knowledge graph is the graph is interpretable by LLMs without requiring any additional programming or instruction. The LLM is only told to interpret the document and extract the data by validating against the knowledge graph.

Customized Prompt Engineering including creation of prompts designed to guide the LLM on specified data extraction tasks, including instructions to ignore irrelevant sections, focus on particular data fields, or extract tabular data in a chosen format.

Post-processing and Optimization including cleaning, structuring, and formatting extracted data into outputs such as JSON, XML, or database entries and validation of extracted data and optimization procedures to ensure conformance with desired accuracy standards.

By addressing known limitations of both OCR-based and LLM-based extraction techniques, the invention provides a robust solution for structured data extraction from complex or inconsistent document types.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates the end-to-end data pipeline from ingestion to structured data output, highlighting the modular architecture.

FIG. 2 illustrates a knowledge graph specific to family offices, showing relationships between entities and their role in validation.

FIG. 3 illustrates the application of the knowledge graph in processing capital call documents, showcasing enrichment and validation.

FIG. 4 illustrates an example workflow diagram of the operations of the system disclosed herein.

FIG. 5 illustrates a mobile device used to implement one or more components of the system disclosed herein.

FIG. 6 illustrates a computing device used to implement one or more components of the system disclosed herein.

### DETAILED DESCRIPTION

A method and system are disclosed for improving the accuracy, efficiency, and scalability of data interpretation and extraction of structured data from unstructured documents utilizing Large Language Models (LLMs). Applicable in finance, healthcare, legal, and government contexts, the disclosed invention addresses limitations of conventional Optical Character Recognition (OCR), machine learning, and LLM-based methods. In particular, the system and method incorporate feedback loops for continuous learning and leverage pre-processing, contextual tagging, customized prompt engineering, and post-processing to achieve robust data extraction. By integrating data enrichment techniques, the invention manages the inherent complexities of multilingual documents and evolving content standards.

The technology disclosed herein addresses persistent challenges in extracting structured data from unstructured documents with inconsistent formats, specialized jargon, and complex layouts. Current OCR and LLM-based methods face limitations with multilingual and contextually ambiguous content. By integrating LLM capabilities with advanced pre-processing and enrichment, this invention offers a robust solution for structured data extraction.

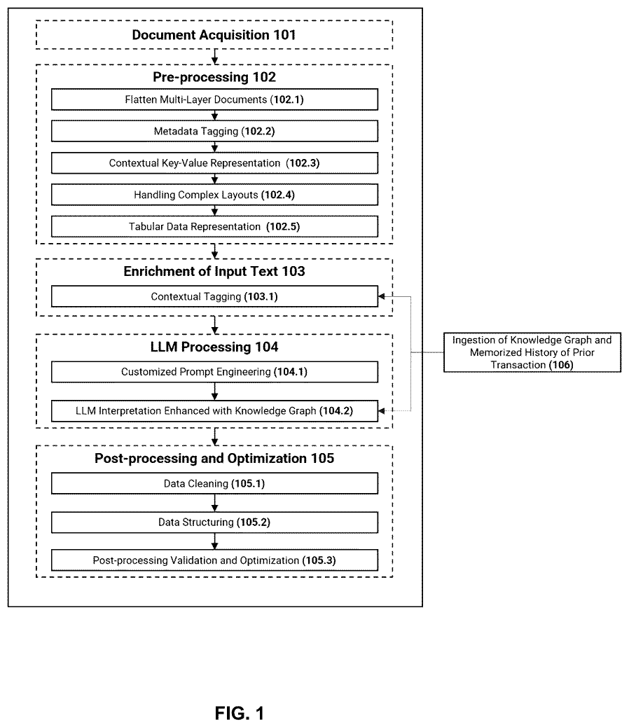

FIG. 1 illustrates the end-to-end data pipeline from ingestion to structured data output, highlighting the modular architecture. At operation 100, document acquisition 101 is completed. Specifically, at operation 100, the foundational layer ingests unstructured (e.g., documents, spreadsheets) formats. It serves as the base of the information architecture, providing the primary content for subsequent processing. In one implementation, the operation 100 may ingest a wide range of file types, including PDF, Word (DOC), Excel (XLS), scanned images (e.g., JPG, PNG, TIFF), HTML, plain text, XML, and CSV. For scanned images, Optical Character Recognition (OCR) technology is used to convert image data into text suitable for Large Language Model (LLM) processing.

Subsequently, at operation 102 the system pre-processes and performs metadata layering. Specifically, at operation 102.1, multilayer documents are flattened. Such flattening may include pre-processing or cracking the document file and it may encompass flattening multi-layer documents, capturing positional information (e.g., headers, footers, and table layouts), Advanced algorithms (e.g., Recursive X-Y cut, Voronoi diagrams) transform multi-layered documents into a single-layer format. This preserves essential semantic relationships, reducing complexity while retaining contextual integrity.

At operation 102.2 data is tagged with metadata. In one implementation, the metadata may include file format, size, keywords, timestamps, and source identifiers. By adding this organizational layer, raw content becomes more manageable, discoverable, and accessible through improved searching, indexing, and sorting.

An operation 102.3 generates contextual key-value representation. Specifically, at operation 102.3, text parsing algorithms (e.g., context-free grammars) may convert content into key-value pairs, enhancing contextual clarity and facilitating data extraction from invoices, forms, and other document types.

Subsequently, at operation 102.4 complex layouts are processed. Specifically, the operation 102.4 ensures that the system accommodates multi-column formats, tables with nested or merged headers, headers/footers, and embedded diagrams or images—ensuring layout fidelity and preserving relational context during pre-processing.

At operation 102.5, tabular data representation is generated. Specifically, operation 102.5 may use specialized techniques to organize tabular data into structured formats (e.g., JSON), capturing both positional and relational information (such as rows, columns, and nested cells) for accurate downstream processing.

An operation 103 provides enrichment of the input text at a semantic layer. Specifically, operation 103 performs contextual tagging 103.1. In one implementation, this layer expands on metadata by creating a network of relationships and meanings among different pieces of data. It does so by integrating metadata from an external knowledge graph or semantic network, which reflects real-world concepts, entities, and their interrelationships that represent the wider world around the document.

This organized structure provides the AI with a contextual “understanding,” enabling deeper, more meaningful analysis. By linking disparate data points, the knowledge graph uncovers insights and knowledge that might otherwise remain hidden.

Machine learning models then generate contextual tags by leveraging knowledge graphs and metadata. These tags enhance the LLM's ability to extract accurate information from documents of varying complexity. They rely on ontologies (e.g., product or service classifications), taxonomies (e.g., biological classifications), entity relationships (e.g., customer-product-service connections), and linked data structures (e.g., the Semantic Web) to provide a cohesive and comprehensive understanding of the data.

Subsequently, at operation 104 LLM processing is performed. Specifically, an operation 104.1 performs customized prompt engineering where prompts are carefully designed to instruct the LLM in extracting specific data fields (e.g., invoice numbers, total amounts), as well as ignoring irrelevant or redundant information. Subsequently, at operation 104.2 the LLM interpretation is enhanced with knowledge graph. For example, the pre-processed and enriched text is input into the LLM, which converts the document content into a structured, machine-readable format. The extracted results may be compared to a knowledge graph for additional validation or cross-referencing.

An operation 105 represents post-processing and optimization. Specifically, at operation 105.1, data cleaning is performed where regular expressions and other filtering techniques remove superfluous labels and standardized prefixes. At operation 105.2, data structuring is accomplished where the cleaned data is transformed into formats such as JSON, XML, or database entries for downstream usage (e.g., analytics, auditing, storage). Subsequently, at operation 105.3, post-processing validation and optimization are performed where the extracted data is re-validated against a knowledge graph or metadata store to detect any inconsistencies and ensure semantic correctness.

An operation 106 the knowledge graph is ingested and memorized history of the prior transaction is generated.

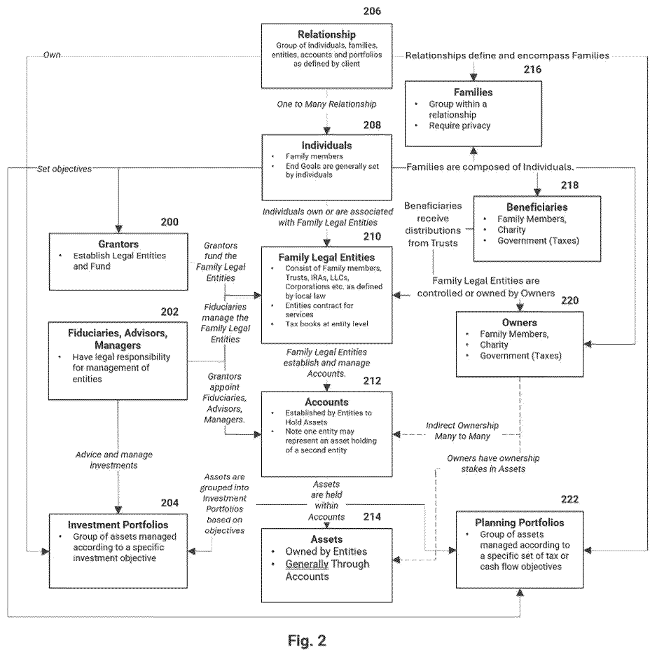

FIG. 2 illustrates a knowledge graph specific to family offices, showing relationships between entities and their role in validation. Specifically, the knowledge graph disclosed in FIG. 2 includes grantors 200 that establish legal entities and funds. Fiduciaries, advisors, and managers 202 that have the legal responsibility for the management of the entities generated by the grantors 200. The fiduciaries, advisors, and managers 202 may advise and manage investments in an investment portfolio 204. Specifically, the investment portfolio 204 may include groups of assets that are managed according to specific investment objectives.

The knowledge graph also includes relationships 206 between groups of families, entities, accounts, and portfolios as defined by the client. The relationships 206 may have a one-to-many relationship with individuals 208, which may include family members. The individuals 108 may own or are associated with family legal entities 210. For example, the family legal entities 210 may include family members, trusts, IRAs, LLCs, corporations, tax books at entity levels, etc. The family legal entities 210 may establish accounts 212 to hold assets, in some cases, one entity may represent an asset holding of a second entity. One or more of the accounts 212 may hold assets 214. The assets 214 may be owned by entities, generally through accounts 212, but may be outside of accounts 212 as well.

The relationships 206 may define and/or encompass families 216. For example, a family 216 may represent a group within a relationship 206. The families 216 and the individuals 208 may have beneficiaries 218. For example, the beneficiaries may be other family members, charities, government entities, etc. The family legal entities 210 may be controlled and/or owned by owners 220. For example, the owners 220 may include family members, charities, government entities, etc. The individuals 208 may set objectives that are used for planning portfolios 222. For example, the planning portfolios 222 may be a group of assets managed according to a specific set of tax or cashflow objectives.

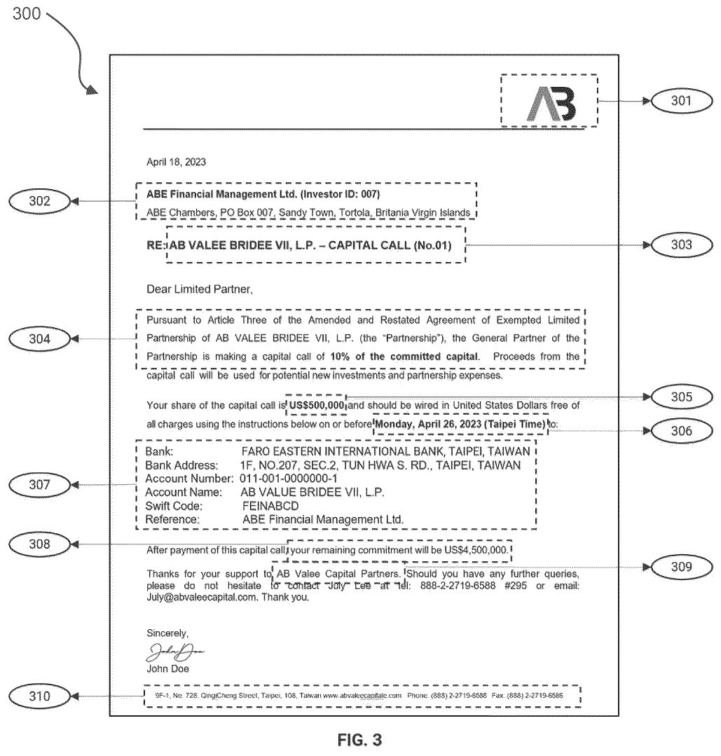

By structuring the key entities (individuals, legal entities, accounts, assets, etc.) and the roles they play (owners, beneficiaries, fiduciaries, etc.) into discrete categories, the knowledge graph cleanly captures who does what and how they're connected. Each relationship—ownership, control, management, etc.—is explicitly modeled as a link between nodes, allowing immediate clarity on how a wealth owner, their family, and various entities or advisors interrelate. Moreover, documents such as capital calls, subscriber agreements, and other compliance records can be attached to the relevant entities or relationships, thereby validating each component and ensuring a verifiable, consistent representation of all critical connections in a flexible, easily navigable manner. FIG. 3 below provides the association of the knowledge graph with the associated document being processed.

Specifically, FIG. 3 illustrates the application of the knowledge graph in processing capital call document 300, showcasing enrichment and validation. In the illustrated implementation, one sample document 300 is described only for illustration purposes. The same principles can be applied to any documents associated with wealth management, family offices and wealth owners e.g. bank statements, subscriber agreements, distribution notices, invoices, trust documents, etc. For example, the name of the entity of the Fund asking for funds, through a capital call as shown by 301, 309, and 310. The logo 301 of the Fund and the address 302 of the fund may be matched against the Investment Portfolio (204) in the knowledge graph.

The entity 303 making the investment and paying the requested amount may be matched against the family legal entities (210). The actual fund (303), the agreement (304), the capital commitment (305), the due date (306) and the remaining commitment (308) can be matched against the investment portfolios (204) and planning portfolios (222) and their associated documents. The OCR may also determine the bank data 307 for making the entity to meet the capital call as per the capital call document 300.

The process ensures that the extraction process is less recognition process but much more a validation process against baseline documents, for validation of the document 300.

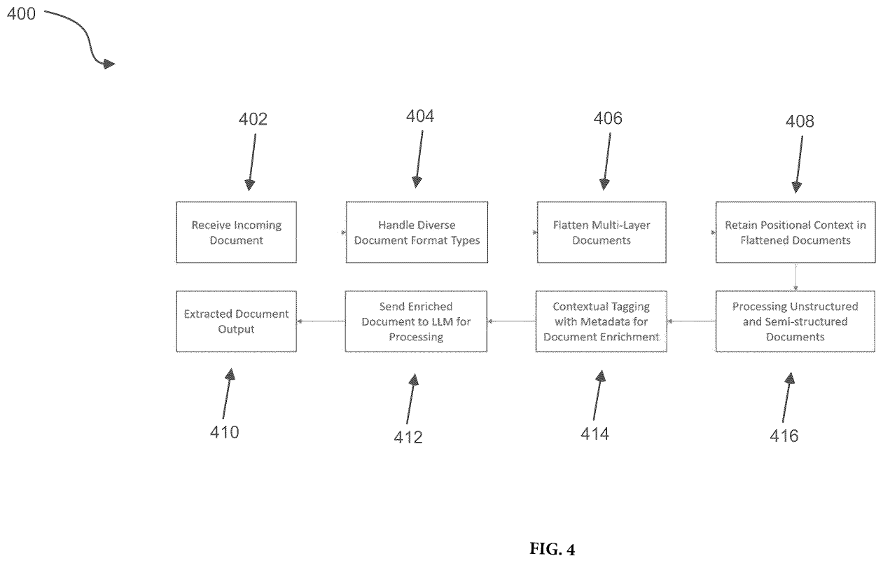

FIG. 4 illustrates an example workflow diagram 400 of the operations of the system disclosed herein. An operation 402 receives incoming document. This is the initial stage where the system receives the document to be processed. The document could be in any format, such as PDF, DOCX, or an image file.

An operation 404 identifies and processes various document formats. It uses specialized algorithms to support a wide array of formats (e.g., PDF, DOCX, HTML, TIFF) and prepares them for further processing.

An operation 406 flattened Multi-Layer Documents. Here, the system applies advanced algorithms, such as Recursive X-Y cut and Voronoi-diagram-based methods, to transform multi-layered documents into a single-layer, flat ASCII format. This step maintains the semantic integrity and relational context of data across different document layers, which is crucial for the accuracy of subsequent processing steps.

An operation 408 retain positional context in the flattened documents. After flattening, the system uses state-of-the-art parsing algorithms to preserve the positional context of information within the documents. This ensures that the layout and format of the original document are retained in the digital representation.

An operation 410 provides contextual tagging with metadata for document enrichment. At this point, the system implements machine learning models and LLMs to generate contextually relevant metadata tags. These tags enrich the document with additional context, aiding the LLM in more accurate interpretation of the text.

An operation 412 sends enriched document to LLM for Processing. The enriched and pre-processed document is now ready to be interpreted by the Large Language Model (LLM). The LLM processes the document, taking advantage of the added contextual tags and structured format to accurately extract and analyze data.

An operation 414 processes unstructured and semi-structured documents. This step involves the system differentiating between unstructured and semi-structured documents using machine learning models and pattern recognition algorithms. It then adapts its processing techniques accordingly to extract relevant information efficiently.

An operation 416 extracts document output. The final output is a structured, machine-readable JSON format that accurately represents the data extracted from the document. This output can then be used for various applications, such as data analysis, reporting, or further computational processing.

While the technology disclosed herein is illustrated in view of financial data, in alternative implementations, the technology disclosed herein may be used for processing of other types of data through data enrichment and contextual tagging. For example, the enhanced OCR processing may be used for processing computer code, GUI images, website data, etc. Alternatively, the enhanced OCR processing may also be used for processing metadata for computing code.

Furthermore, unlike traditional methods, this OCR processing integrates pre-processing with knowledge-based enrichment and LLM-guided extraction to handle variability in document formats. Its modular architecture enables easy updates, and its scalability makes it suitable for high-volume operations.

An implementation disclosed herein includes a system for adaptive LLM performance enhancement, the system including a plurality of dynamic feedback loops for model refinement, one or more language-specific enrichment modules for multilingual content handling, a cross-referencing module for cross-referencing the extracted data against structured knowledge graphs for validation, and an API-based integration module for seamless updates and external system interactions.

An implementation disclosed herein includes a method for structured data extraction from unstructured documents, the method including pre-processing input to standardize document layouts while preserving semantic context, enriching input using dynamic knowledge graphs and metadata for contextual tagging; utilizing prompt engineering to optimize LLM instructions for task-specific data extraction, and applying post-processing for data cleaning, validation, and format optimization.

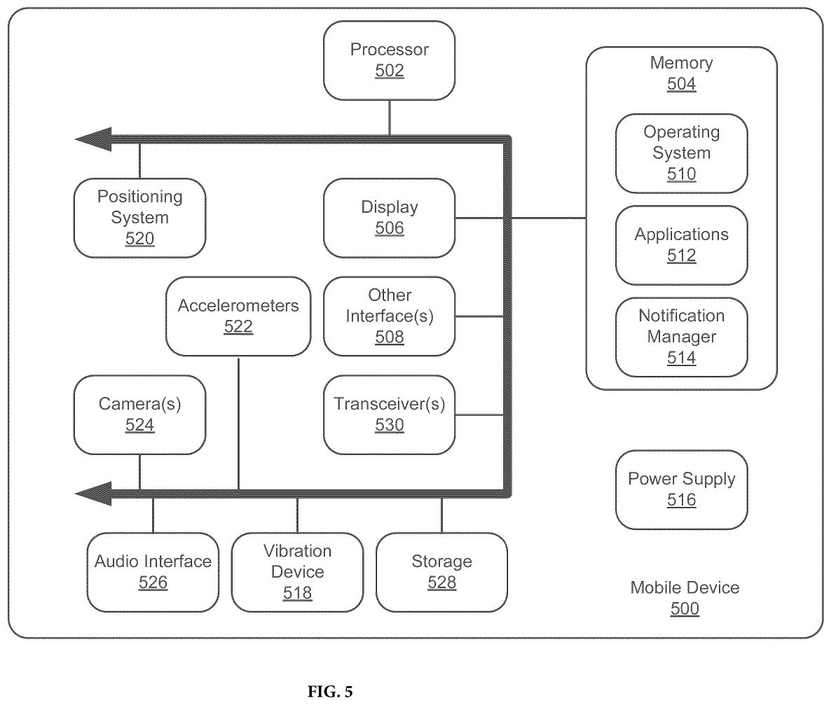

FIG. 5 illustrates a mobile device 500 used to implement one or more components of the system disclosed herein.

The mobile device 500 includes a processor 502, a memory 504, a display 506 (e.g., a touchscreen display), and other interfaces 508 (e.g., a keyboard). The memory 504 generally includes both volatile memory (e.g., RAM) and non-volatile memory (e.g., flash memory). An operating system 510, such as the Microsoft Windows® Phone operating system, resides in the memory 504 and is executed by the processor 502, although it should be understood that other operating systems may be employed.

One or more application programs 512 are loaded in the memory 504 and executed on the operating system 510 by the processor 502. Examples of applications 512 include without limitation email programs, scheduling programs, personal information managers, Internet browsing programs, multimedia player applications, etc. A notification manager 514 is also loaded in the memory 504 and is executed by the processor 502 to present notifications to the user. For example, when a promotion is triggered and presented to the shopper, the notification manager 514 can cause the mobile device 500 to beep or vibrate (via the vibration device 518) and display the promotion on the display 506.

The mobile device 500 includes a power supply 516, which is powered by one or more batteries or other power sources and which provides power to other components of the mobile device 500. The power supply 516 may also be connected to an external power source that overrides or recharges the built-in batteries or other power sources.

The mobile device 500 includes one or more communication transceivers 530 to provide network connectivity (e.g., mobile phone network, Wifi®, BlueTooth®, etc.). The transceiver 530 may be configured to communicate with an NFC tag 509. The mobile device 500 also includes various other components, such as a positioning system 520 (e.g., a global positioning satellite transceiver), one or more accelerometers 522, one or more cameras 524, an audio interface 526 (e.g., a microphone, an audio amplifier and speaker and/or audio jack), and additional storage 528. Other configurations may also be employed.

In an example implementation, a mobile operating system, various applications, and other modules and services may be embodied by instructions stored in memory 504 and/or storage devices 528 and processed by the processing unit 502. User preferences, service options, and other data may be stored in memory 504 and/or storage devices 528 as persistent datastores.

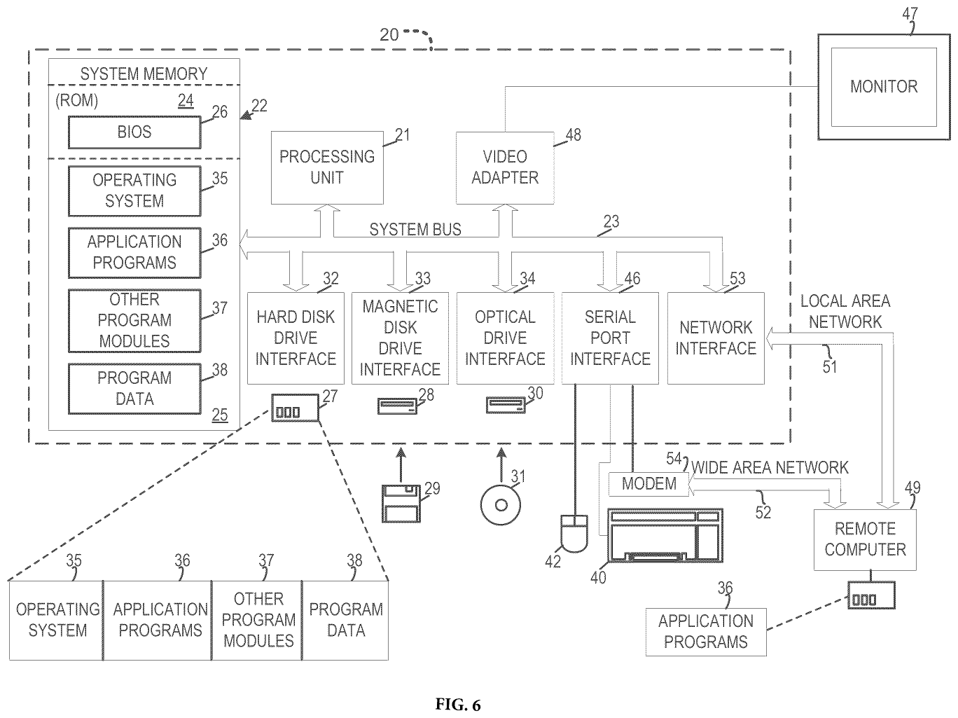

FIG. 6 illustrates an example system that may be useful in implementing the described technology. The example hardware and operating environment of FIG. 6 for implementing the described technology includes a computing device, such as general-purpose computing device in the form of a gaming console or computer 20, a mobile telephone, a personal data assistant (PDA), a set top box, or other type of computing device. In the implementation of FIG. 24, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment.

The computer 20 may be a conventional computer, a distributed computer, or any other type of computer; the implementations are not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory and includes read only memory (ROM) 24 and random-access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 24. The logical connections depicted in FIG. 24 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, software or firmware instructions and data for providing a search management system, various applications, search context pipelines, search services, service, a local file index, a local or remote application content index, a provider API, a contextual application launcher, and other instructions and data may be stored in memory 22 and/or storage devices 29 or 31 and processed by the processing unit 21.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The implementations described herein are implemented as logical operations in one or more computer systems. The logical operations may be implemented (1) as a sequence of processor-implemented operations executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, operations, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

Embodiments of the present technology are disclosed herein in the context of an electronic market system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application- and business-related constraints, and that those specific goals will vary from one implementation to another and from one developer to another.

According to one embodiment of the present invention, the components, process operations, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, California, Windows Vista™, Windows NT®, Windows XP PRO, and Windows®2000, available from Microsoft Corporation of Redmond, Washington, Apple OS X-based systems, available from Apple Inc. of Cupertino, California, or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general-purpose machines; and. In addition, those of ordinary skill in the art will recognize that devices of a less general-purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store,” also referred to by the term “repository,” describes a hardware and/or software means or apparatus, either local or distributed, for storing digital or analog information or data. The term “data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “data store” also describes, by way of example, databases, file systems, record systems, object-oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method for structured data extraction from unstructured documents, comprising:
pre-processing input to standardize document layouts while preserving semantic context;
enriching input using dynamic knowledge graphs and metadata for contextual tagging;
utilizing prompt engineering to optimize LLM instructions for task-specific data extraction; and
applying post-processing for data cleaning, validation, and format optimization.

2. A system for adaptive LLM performance enhancement, comprising:
a plurality of dynamic feedback loops for model refinement;
one or more language-specific enrichment modules for multilingual content handling;
a cross-referencing module for cross-referencing the extracted data against structured knowledge graphs for validation; and
an API-based integration module for seamless updates and external system interactions.
